(19) United States
(12) Patent Application Publication
(10) Pub. No.: US 2011/0295879 A1
(43) Pub. Date: Dec. 1, 2011

(54) SYSTEMS AND METHODS FOR DOCUMENT MANAGEMENT

(75) Inventors: Elten Hermanto Logis, Austin, TX (US); Christopher Laurence Albury, Round Rock, TX (US); I-Hsing Tsao, Austin, TX (US)

(73) Assignee: NEUONE, LLC, Austin, TX (US)

(21) Appl. No.: 12/833,995

(22) Filed: Jul. 11, 2010

Related U.S. Application Data
(60) Provisional application No. 61/348,808, filed on May 27, 2010.

(51) Int. Cl. G06F 15/16; G06F 17/30; G06F 3/048

(52) U.S. Cl. 707/769; 709/219; 707/802; 715/764; 707/E17.014; 707/E17.044

(57) ABSTRACT

Systems and methods for document management are presented. A virtual document, irrespective of a number of pages in the virtual document, may be transferred to a device via a network within a time period similar to or approximately equal to a time period to transfer a single page document. The systems, database structures, and methods described herein can allow for the management of a document similar to that of a file system, by allowing each individual page of a multi-page document to be stored and updated individually. In some embodiments, multi-page image documents may be stored at a page level, that is, each page of a multi-page image document may be individually stored and individually accessed, allowing for a random access of any page within a multi-page image document without a need to access any other pages of the multi-page image document.

### CROSS REFERENCE TO RELATED APPLICATION

The present application claims priority to pending U.S. provisional patent application Ser. No. 61/348,808, filed May 27, 2010, and entitled “Systems and Methods for Document Management”, the content of which is hereby incorporated by reference in its entirety.

### BACKGROUND

Delivery of documents over a network can encounter problems due to bandwidth issues, a size of the documents, or the relative size of both. For example, a multi-page image document may include several megabytes of data or more. The size of documents like these may be too large to transfer quickly over a network due to available bandwidth of the network. For example, in mobile applications and other lower bandwidth implementations, downloading of image documents can take a significant amount of time.

### SUMMARY

Disclosed herein are systems and methods to facilitate efficient management and delivery of documents. Systems and methods for transferring image documents are presented that, generally, allow for multi-page image documents to be transferred quickly, independent of a number of pages in the document. In some embodiments, systems and methods may store an image document at a page level, that is, pages of a multi-page image document can be individually stored and individually transferred over a network to a user device (while enhancing the usability of the document such that the users can view the document page by page as in the original, in a desired order, or only the pages containing desired information). Thus, any individual full-size page of a multi-page image document may be transferred separately, allowing for a random access of any page within a multi-page image document without necessarily downloading any other full-size pages of the multi-page image document. These embodiments allow systems to access, transfer, create, or manage a document or virtual document of unlimited page size (subject to whatever hardware and operating system constraints are inherent in the computer system implementing the embodiments). That is, there is no bandwidth constraint due to the size (number of pages or separate images) of the document or the size of a collection of documents. Such selective page transfer can be very beneficial based on a relative size of a document compared to the bandwidth available over a network to transfer a part of the document; for example, the embodiments discussed herein could be very beneficial when a user requests to view a page of a one thousand (1,000) page document and the user has access to a relatively low bandwidth of a network to transfer the document.

In further embodiments, systems and methods may also transfer one or more thumbnail images of other pages. A thumbnail image may be used to aid the usability and viewing of documents so users can quickly browse, such as scrolling, through multiple pages. Other pages to transfer, or thumbnails representing other pages, may be determined based on a relative position of the page within the multi-page image document, a search result of the multi-page image document, a search result of multiple documents, pointers to related documents or pages, a total number of pages in the multi-page image document, other criteria, or any combination thereof.

### BRIEF DESCRIPTION OF DRAWINGS

FIG. 1 is a diagram of an embodiment of a system for document management;

FIG. 2 is a flowchart of an embodiment of a method for document management;

FIG. 3 is a flowchart of another embodiment of a method for document management;

FIG. 4 is a flowchart of another embodiment of a method for document management;

FIG. 5 is a block diagram of an embodiment of a database structure for use in system for document management;

FIG. 6 is a flowchart of an embodiment of a method for building documents for use in a document management system;

FIG. 7 is a diagram of an embodiment of a graphical user interface (GUI) for logging into a document management system;

FIG. 8 is a diagram of an embodiment of a GUI for searching within a document management system;

FIG. 9 is a diagram of an embodiment of a GUI for document management;

FIG. 10 is a diagram of an embodiment of a GUI for document management; and

FIG. 11 is a diagram of an embodiment of a GUI for document management.

### DETAILED DESCRIPTION

In the following detailed description of the embodiments, reference is made to the accompanying drawings, which form a part hereof and show specific embodiments by way of illustration. It is to be understood that other embodiments may be utilized and structural changes may be made without departing from the scope of the present disclosure.

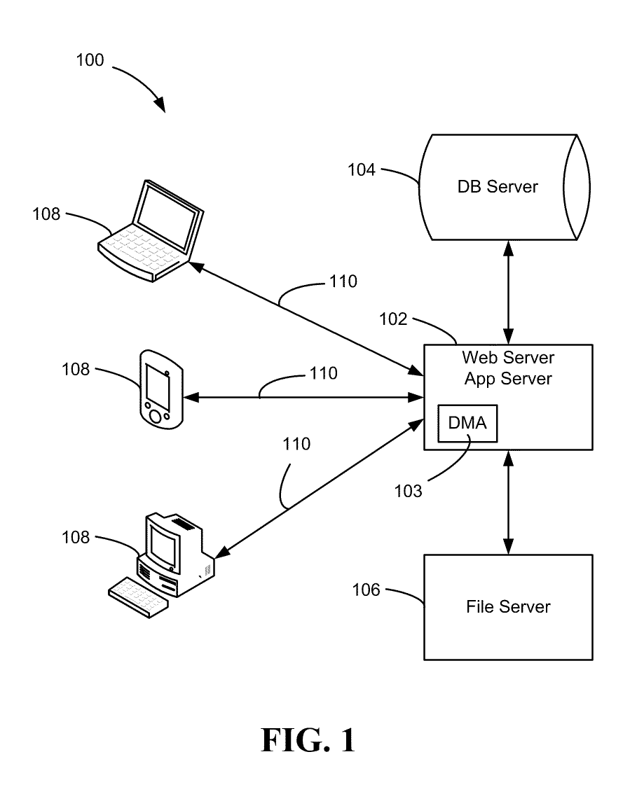

FIG. 1 is a diagram of an embodiment of a document management system 100. The document management system 100 may include a server 102, a database server 104, and a file server 106. The server 102, the database server 104, and the file server 106 may be directly connected, connected through a network, connected through other devices, or any combination thereof, and may comprise one or more physical servers. In a specific embodiment, servers 102, 104, and 106 may be implemented as different processes executing on a single computing system. The server 102 may be an application server configured to provide a document management application 103 to a client 108 over a network 110. The client 108 may be any type of computing device, including, but not limited to, a laptop computer, a desktop computer, a telephone (mobile, smart phones, etc.), a personal digital assistant, a tablet computer, a television, a display screen, or any electronic device having a network connection, a memory, and a processor configurable to display a graphical user interface (GUI) and receive user input related thereto. The network 110 may be a local area network, such as an intranet or wide area network, such as the Internet, and may be wired or wireless.

The server 102 may be coupled to the database (DB) server 104 and the file server 106, either through direct connections, via a network, or through intervening devices (not shown). The database server 104 may be any type of server that can implement a database structure and functionality including receiving queries, retrieving database records, and providing database record(s) in response to a received query. In one embodiment, the database structure could be any relational database, such as an SQL database. In another embodiment, the database structure could be an object-oriented database. The file server 106 may be any type of server configured with a file management system.

The document management application 103 may be a stand-alone software application or a software application that is provided to the client 108 via another application, such as a browser or media player. The document management application 103 can allow a user of the client 108 to view one or more images associated with a file or document, such as a multi-page image file. A multi-page image file may be a Portable Document Format (PDF), Portable Network Graphic (PNG), Tagged Image File Format (TIFF), or any other type of image file.

In an embodiment, the systems and methods described herein could be accomplished using single page image files. In one embodiment, a single page of a multi-page image document may be provided to the client 108. In another embodiment, the images provided to the client 108 may include at least one full-size page image and at least one thumbnail image of another page.

As used herein, a “full-size page”, “full-size page image”, or “full-size image” means a version of a page or a document that has a higher image resolution than a thumbnail image. As used herein, a “thumbnail image” or “thumbnail” means a smaller graphic associated with a larger image, where the smaller graphic occupies less memory space than the larger image occupies. In some embodiments, the thumbnail image may be derived from the full-size page image. In other embodiments, a thumbnail may be provided to a user along with an associated link to allow the user to access the full-size image.

In some embodiments, the document management software may provide multiple thumbnails of other pages, such as five (5) thumbnail images of other pages, to the client 108. Also, multiple full-size pages, whether consecutively or non-consecutively ordered in an original document, may be delivered to the client 108. For example, the document management system 103 may provide to the client 108 a first page of a document and other selected pages of the document or other pages from other documents. Each full-size page may be sent to the client 108 in an individual transfer transaction.

Further, the document management software 103 may allow the client 108 to perform a search, such as a full text search, within a single document or within a collection of documents. Search results may show full-size pages or thumbnails of individual pages that match the search string. In some instances, server 102 may include query expansion logic adapted to selectively expand a search string to include additional related terms. Thus, the search results may include pages that are related to a query. Such search results may include pages from a whole collection of documents, a subset of the collection, or may be limited to a single document. In another embodiment, pages located relatively to a selected page of a document may be shown via thumbnail images. Subsets of a collection of documents may be searchable based on keyword associations of the subsets. The keyword associations may be from user input, automatically generated, or another method. Thus, a user may limit a search to a specific subset of documents based on a category, heading, or keywords associated with the subset.

In one embodiment, during operation, the server 102 may receive a request from a client 108 to view a file or a specific page in a file. For example, this may be accomplished by a user selecting a file through an application, such as DMA 103, loaded into (or connected to via an interface, such as via internet protocols) a browser from the server 102. This may also be accomplished by any software configured to issue requests to the server 102 and display the results of the request. The server 102 may issue a query based on the requested file or page to the DB server 104. The DB server 104 may return results based on the query. The results may include one or more items, such as information related to a page, multiple pages, a thumbnail, multiple thumbnails, a full-size page, multiple full-size pages, a document, multiple documents, or any combination thereof. The information provided by the DB server 104 may include location information of the one or more items, information indicating a relationship between any number of the items, information indicating a display order of the items, other information related to the items, or any combination thereof.

In one embodiment, the results may include location information for the specific page or file. In another embodiment, the results may also include location information for other pages or other files determined to relate to the query. In yet another embodiment, the DB server returns location information for one or more full-size pages and location information for one or more thumbnail images, five (5) for example. The determination of what relates to the query may be determined by the client 108, a user input, the application 103, the server 102, information from the DB server 104, another device or software, user generated information, or any other information. For example, a user or administrator may add information to a document or file that relates the document or image file to another document.

Once the server 102 has the location information from the DB server 104, the server 102 issues a request to the file server 106 to retrieve one or more of the items. In a specific embodiment, server 102 issues a request for at least one full-size page and at least one thumbnail and the file server 106 provides the full-size page image file and the thumbnail image file(s) to the server 102 in response to the request.

Once the items have been received at the server 102, the items may be sent to the requesting client 108. In a specific embodiment, the server 102 transfers the items to the requesting client 108 to display in a view, such as a hyper-text markup language (html) page, within a client browser or other application. In another embodiment, the server 102 may transfer the items to the client 108 to be saved, such as locally at a memory of the client 108.

The server 102 may also transfer other items, such as non-requested items, to the requesting client 108. This may be done as a background operation that is not visible to a user of the client. The other items may be determined based on a read look-ahead algorithm. A read look-ahead algorithm may be able to determine other items that might be requested by the client 108 and may be configurable to adapt to user behavior, system performance, object properties, network properties, or any combination thereof. For example, the other items may include one or more pages from a multipage document that are in proximity to the requested page, other pages that are identified in a search result, or other pages that have a relationship to the requested page, such as through a link, bookmark, semantic analysis, or user generated information. The read-look ahead function may be configurable, by a user or system administrator, as to the number of pages or thumbnails that are transferred without being requested.

In some embodiments, an end user may perform a search on multiple documents, such as a whole collection of documents or a subset of the collection of documents. The client 108 may issue a request, via the DMA 103, to the server 102 to initiate a search of the multiple documents. The server 102, via a software program that can receive the information from DMA 103 and issue queries, may issue one or more queries to the DB server 104 based on the request from the client 108. In response to the one or more queries, the DB server 104 may return results of one or more items, which may include location information of images or documents. Once the server 102 receives the results, the server 102 may use any location information included in the items to issue a request to the file server 106 to retrieve any images or files corresponding to the location information. The file server 106 may then provide the requested item or items to the server 102, which may then send the item or items to the client 108. In a particular embodiment, at least one full-size page and multiple thumbnails, possibly from different files, are provided to the client 108 in response to the request. For example, a user may do a keyword search on a collection of files and the results provided to the user may include a result having the keyword that include a full-size page and at least one thumbnail of another page from another file that also includes the keyword. In another example, multiple thumbnails, each representing a page from a different file where the page includes the keyword, may be provided as a result to the client 108. In another example, multiple thumbnails representing multiple pages, each of which may satisfy the search criteria, may be presented to the client 108. The multiple thumbnail images may represent pages from one file, a whole collection of files, a subset of a collection of files, multiple collections of files, or any combination thereof.

In another embodiment, after the client 108 has received a response including at least one thumbnail image, the user may select the thumbnail image to view the page or document corresponding to the thumbnail image as a full-size page. The full-size page corresponding to a selected thumbnail may be loaded into a view of the client 108 from a cache when the corresponding full-size page is available in the cache. For example, the corresponding full-size page may have been pre-loaded into a cache of the client 108 due to a read look-ahead operation performed by the client 108 or at the server 102. If the corresponding full-size page is not in a cache of the client 108, the corresponding full-size page may be requested from the server 102.

The server 102 may then issue a query based on the requested full-size page to the DB server 104. In response to the query, the DB server 104 may return results including location information of the requested full-size page. Once the server 102 has the location information from the DB server 104, the server 102 may issue a request to the file server 106 to retrieve the requested full-size page. The file server 106 may then provide the requested full-size page to the server 102, which may then send the full-size page to the client 108.

When a thumbnail is selected by the client 108, the server 102 may also perform other functions in addition to retrieving the requested page or file. For example, the server 102 may also send other images, files, thumbnails, information, or any combination thereof to the client 108 in response to, based on, or in conjunction with retrieving a requested image or file. The server 102 may update the items or information sent to the client 108 periodically, upon an action by the client 108, in response to other criteria such as relationship information of a requested file, or any combination thereof. For example, anytime the client 108 requests a new full-size page from the server 102, the server 102 may update the thumbnails and information that was sent to the client 108. The update may include thumbnails, information, links to other files, read look-ahead data or files, or any combination thereof based on the most recently requested image or file.

In the systems and embodiments as described above, random access of pages or documents within a file may be accomplished through logical segmentation of the file and page can be accessed randomly from an end user perspective. In some embodiments, only segments of interest to the end user are transferred to the client 108. In addition, the above systems and embodiments provide flexibility to transfer other related information to the client 108, such as related thumbnails, documents, files, other information, or any combination thereof.

Also, the systems and embodiments described herein can allow a merge of thousands of documents or pages to make a large virtual document, without changing the underlying pages or documents. A virtual document may be a document that is comprised of multiple files that are related through a database or metadata. There may be no actual single document having all the pages stored within one file. Further, a system may allow for different views (or different virtual documents) that use at least part of the same underlying documents or pages. The different views may be associated with specific user types, classifications, or security settings to provide different users with different views (or different virtual documents). The different views may be constructed based on indicators or pointers associated with each page that is to be included in a particular view or virtual document. Access controls or security settings may allow different users or different classifications of users to access certain views, documents, pages, or virtual documents. The access controls may also be associated with profiles tailored to specific people, access levels, or different classifications of users. The profiles may be tailored to specific disciplines or requirements.

The systems and methods described herein may be applied to systems other than image document systems. For example, the same technology can be applied to movies. A movie may be segmented and stored in smaller segments, information about the segments may be stored at the DB server 104, and the movie segments may be stored at the file server 106. In some embodiments, a movie may be segmented based on a number of frames, scenes, a length of time, or any other criteria. Thus, end users may be able to watch a segment of interest, while having thumbnails or links to one or more later segments, that when selected does not require the server 102 to stream any segments that might normally occur between a first selected segment and a later selected segment. In addition, the DB server 104 can also provide functionality to allow information about each segment to be displayed, such as running time, location within the movie as a whole, keywords associated with the segment, people or events appearing in the segment, music within the segments, a rating of the movie or segment, any other information about the segment or movie, or any combination thereof.

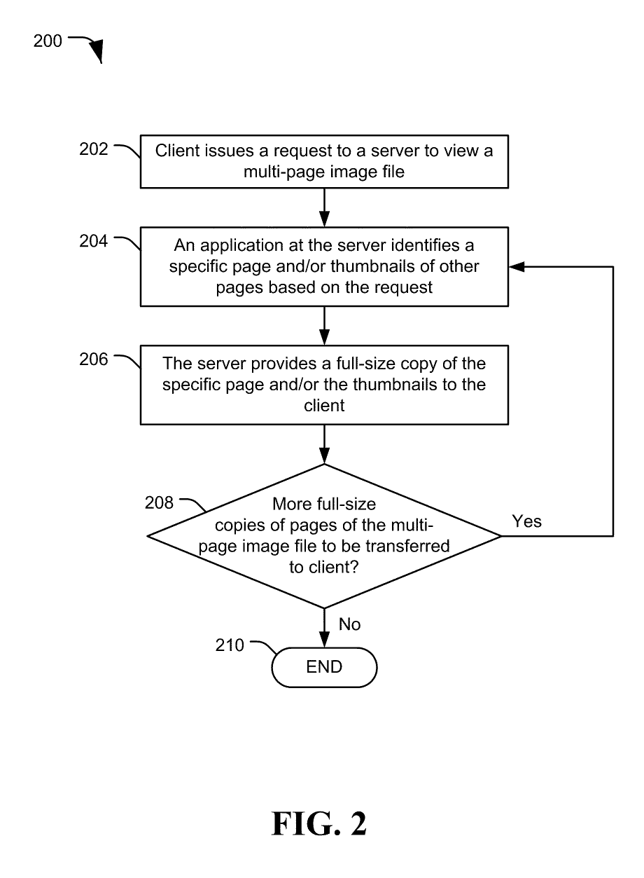

FIG. 2 is a flowchart of an embodiment of a method for document management 200. The method for document management 200 may be implemented via an application on a computer or server, though the configuration of the application(s) and server(s) can include any configuration that can implement the methods discussed herein. For example, the method for document management 200 may be implemented via the system 100 depicted in FIG. 1.

Generally, the method for document management 200 provides a method for a client to retrieve at least one full-size page of a multi-page image document. The method 200 may include receiving a request at a server to view at least one page of a multi-page image file, at 202. The request may come from a client device, such as a client 108 in FIG. 1. Then, an application at the server can identify items, such as a specific page and/or thumbnail, associated with the request, at 204. The application may identify any combination of multiple pages and multiple thumbnails that may be associated with the request, either directly or indirectly.

Once identified, the server can provide the items to the client, at 206. In a specific embodiment, the server provides a single full-size copy of a specific page to the client. In another embodiment, the server additionally provides at least one thumbnail image to the client. The thumbnail image may include a link to another page of the same document as the full-size page or a link to a page from a different document.

The method 200 then determines if there are more items to transfer, such as determining if there are more full-size pages of the multi-page image file to be transferred to the client, at 208. If there are more items to transfer, the method 200 returns to identifying the times to transfer, at 204. If there are no more items to transfer, the method 200 ends at 210.

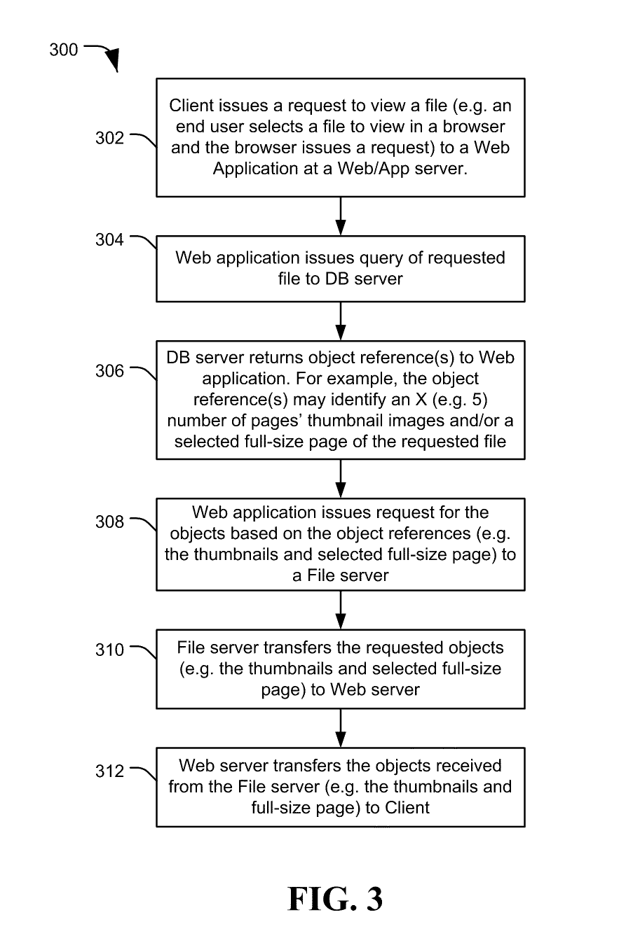

FIG. 3 is a flowchart of an embodiment of a method for document management 300. The method for document management 300 may be implemented via an application on a computer or server, though the configuration of the application(s) and server(s) can include any configuration that can implement the methods discussed herein. For example, the method for document management 300 may be implemented via the system 100 depicted in FIG. 1.

The method 300 may include receiving a request to view a file at an application server; the request may be received from a client device over a network. In one embodiment, an end user of the client device may select a file to view in a browser that can run a web application from the application server. An application at the application server may receive the request and issue a query to a database (DB) server for information related to the file, at 304. The information may include location information of a page within the file. The application may query the DB server for a specific file or page requested by the client device along with additional pages, thumbnail images, documents, or files that the application may determine to also send to the client device.

The DB server may return the information to the application as one or more object references, at 306. The object references may identify a location of the items to be transferred to the client device, such as a full-size image and/or one or more thumbnail images. Once the application has the information from the DB server, the application may issue a request to a file server to retrieve the objects or items, at 308. The request may include location information of the objects or items that was received from the DB server. The file server may then transfer the requested objects or items to the web/application server, at 310. Once the application has the objects or items from the file server, the web server may transfer them to the client device, at 312.

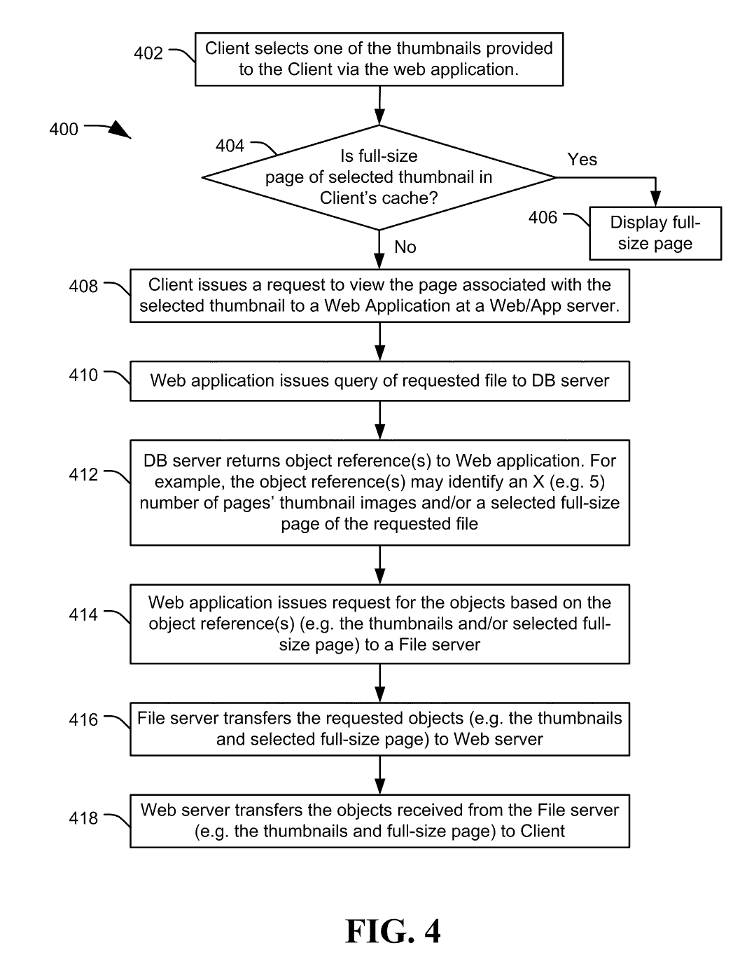

FIG. 4 is a flowchart of an embodiment of a method for document management 400. The method for document management 400 may be implemented via an application on a computer or server, though the configuration of the application(s) and server(s) can include any configuration that can implement the methods discussed herein. For example, the method for document management 400 may be implemented via the system 100.

The method 400 may be performed by a browsing application at a client device, such as an internet browser loading an application from a web server, a stand-alone document viewing application, or an application at a server that connects to a client device via a network. The method 400 may include a client device, possibly via a user input, selecting a thumbnail image and associated link to view, at 402. The client device may allow selection of a thumbnail or associated link via a GUI displayed in a browser on the client device. The selection may be made by a user, another application, or another method. A determination may be made by the browsing application whether a full-size page corresponding to the selected thumbnail is already loaded into a cache at the client device, at 404. If the corresponding selected full-size page is in the cache, the browsing application may load the full-size page for viewing from the cache without a need for a transfer transaction from a server, at 406.

If the corresponding selected full-size page is not in the cache, the browsing application can issue a request to transfer the full-size page that is associated with the selected thumbnail, at 408. The request may be sent to an application server linked to the browsing application via a network. The application server may then issue a query to a DB server for the requested full-size page and items related to the requested full-size page such as other pages, thumbnails, documents, or files, at 410.

The DB server may return the requested items to the application server as one or more object references, at 412. The object references may identify a location of the items to be transferred to the client device, such as a full-size image and/or one or more thumbnail images. Once the application server has the requested items from the DB server, the application server may issue a request to a file server to retrieve the objects or items, at 414. The request may include location information of the objects or items that was received from the DB server. The file server may then transfer the requested objects or items to the application server, at 416. In one embodiment, the objects or items received from the files server comprise at least the full-size page that was selected via the client device. Once the application server has the objects or items from the file server, the application server may transfer them to the browsing application, at 418. The application at the client device may then display the full-size image that corresponds to the selected thumbnail.

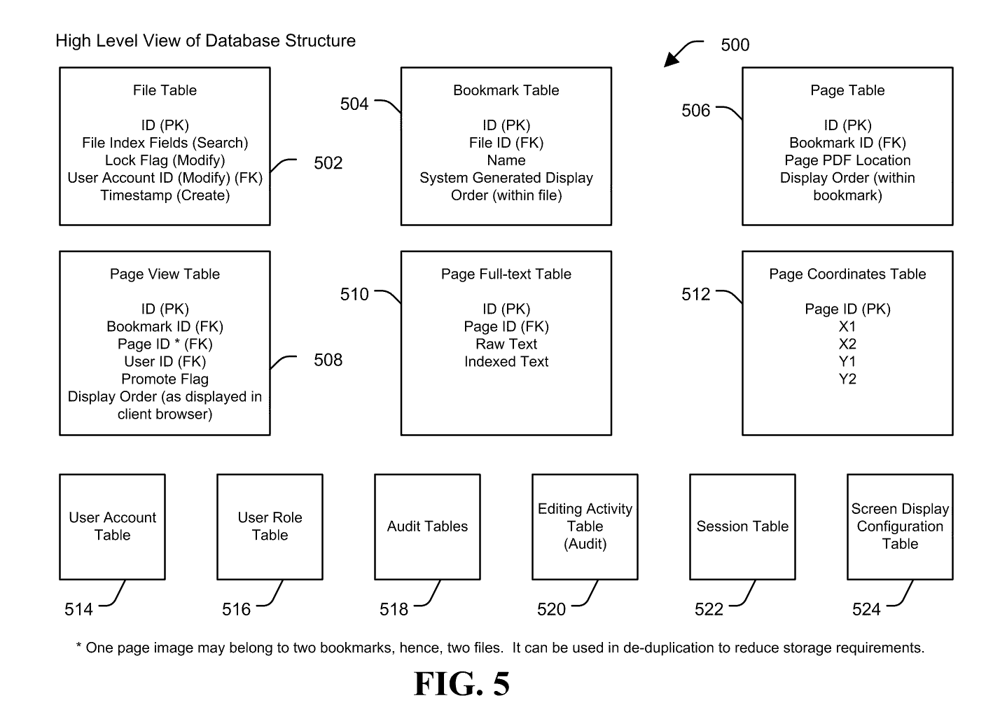

FIG. 5 is a diagram of an embodiment of a system for document management. Generally, FIG. 5 depicts an embodiment of a database structure 500 that may be implemented at the database server 104 shown in FIG. 1 and that may be used to implement the methods described herein. However, any database structure that can accomplish the features and functionality described herein may be implemented. The structure and layout of the database structure 500 can include more or less features than the embodiment shown.

The database structure 500 may include field(s) to store locations of individual full-size pages for each document, field(s) to store locations of thumbnail images for each page of each document, field(s) to store locations of each whole document, field(s) to store an indication of a system generated display order of pages, field(s) to store an indication of an order or pages in a document, field(s) to store information to determine a display order of images within a document or within a search result, as well as other field(s). (As used herein, “(s)” means one or more.)

In a particular embodiment, the database structure 500 comprises a file table 502, a bookmark table 504, a page table 506, a page view table 508, a page full-text table 510, a page coordinates table 512, a user account table 514, a user role table 516, audit table(s) 518, editing activity table 520, session table 522, and screen display configuration table 524.

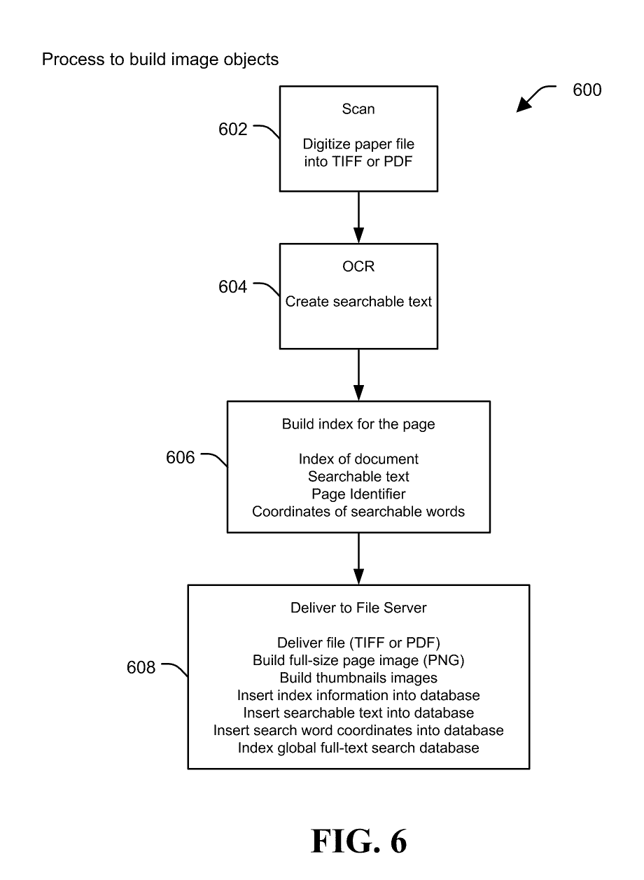

FIG. 6 is a flowchart of an embodiment of a method for document management 600. The method for document management 600 may be implemented via an application on a computer or server, though the configuration of the application(s) and server(s) can include any configuration that can implement the methods discussed herein. For example, the method for document management 600 may be implemented via the system 100.

Generally, the method of document management 600 comprises a method for building or adding to an index or database of document images. However, any method of building a database for use with a document management system may be used, as long as the database allows the functionality of the methods described herein, the document management software to be executed, and the relevant information is retrievable from the database.

In a specific embodiment, the method of document management 600 may include scanning or digitizing files (including, but not limited to, paper files) into an electronic format, such as TIFF or PDF, at 602. The method 600 may also include creating searchable text from the files, at 604. The method can also include building an index for a page of a document in the file, at 606. Building the index may include generating an index of the document, including searchable text, including a page identifier, and including coordinates of searchable words. The method 600 may also include delivering items to the file server, at 608. The items delivered to the file server may include a file, full-size images of pages within the file, thumbnail images corresponding to the file or the pages of the file, index information, searchable text, search word coordinates, a global full-text search, any other information, or any combination of the above.

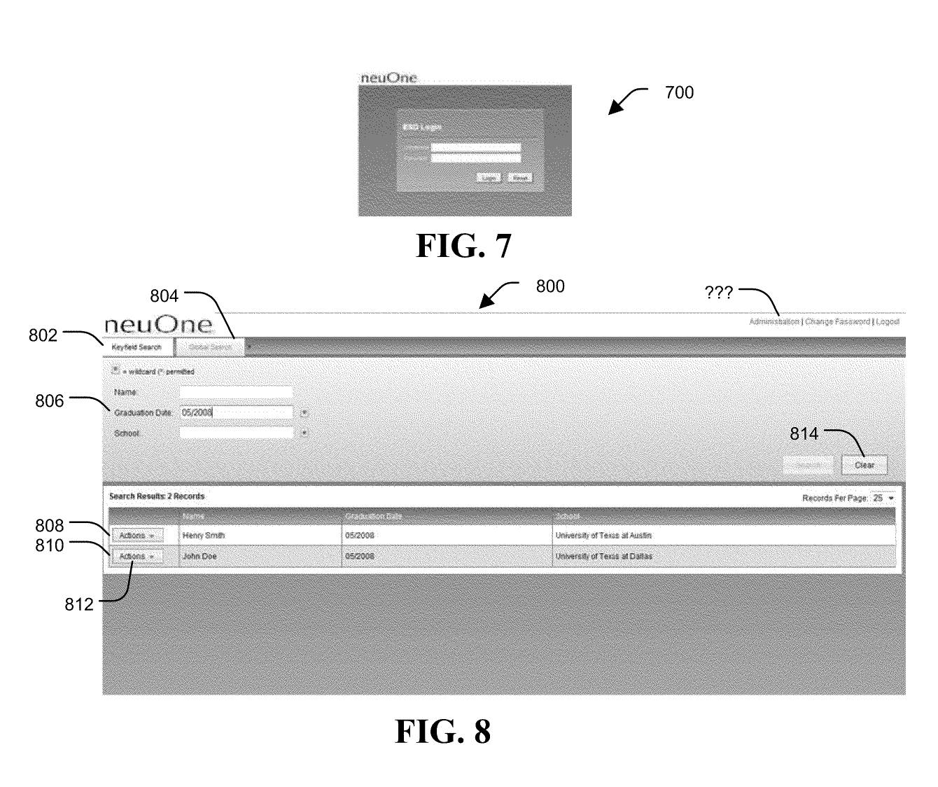

FIGS. 7-11 depict diagrams of embodiments of graphical user interfaces (GUI) for document management. The GUIs shown may be part of an application, executable on a client device, such as via a browser, that can connect to an application server over a network. FIG. 7 depicts a login screen 700 that can provide security to the application of the application server by providing an interface for receiving a username and password which can be authenticated at the server.

FIG. 8 depicts a search screen 800 including a button for a keyword search 802, a button for a global search 804, one or more search fields 806, a search result area showing search results 808 and 810 that each have an action button 812, and a clear button 814.

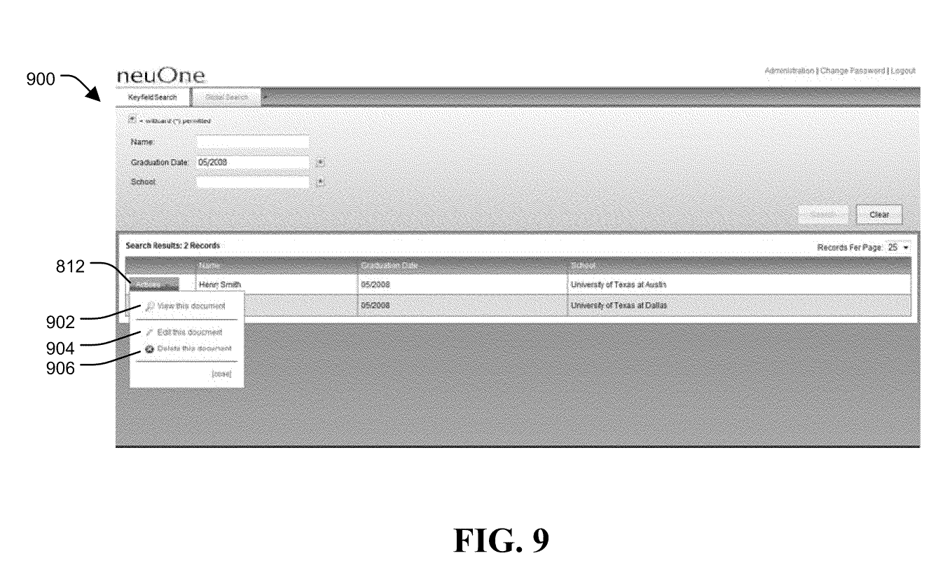

FIG. 9 depicts a GUI 900 including a fly-out menu that may be activated when the action button 812 is selected. The fly-out menu may include actions such as view the document 902, edit the document 904, delete the document 906, or any combination thereof. The fly-out menu may also include other document management actions that are not shown, such as a save document action or a bookmark action.

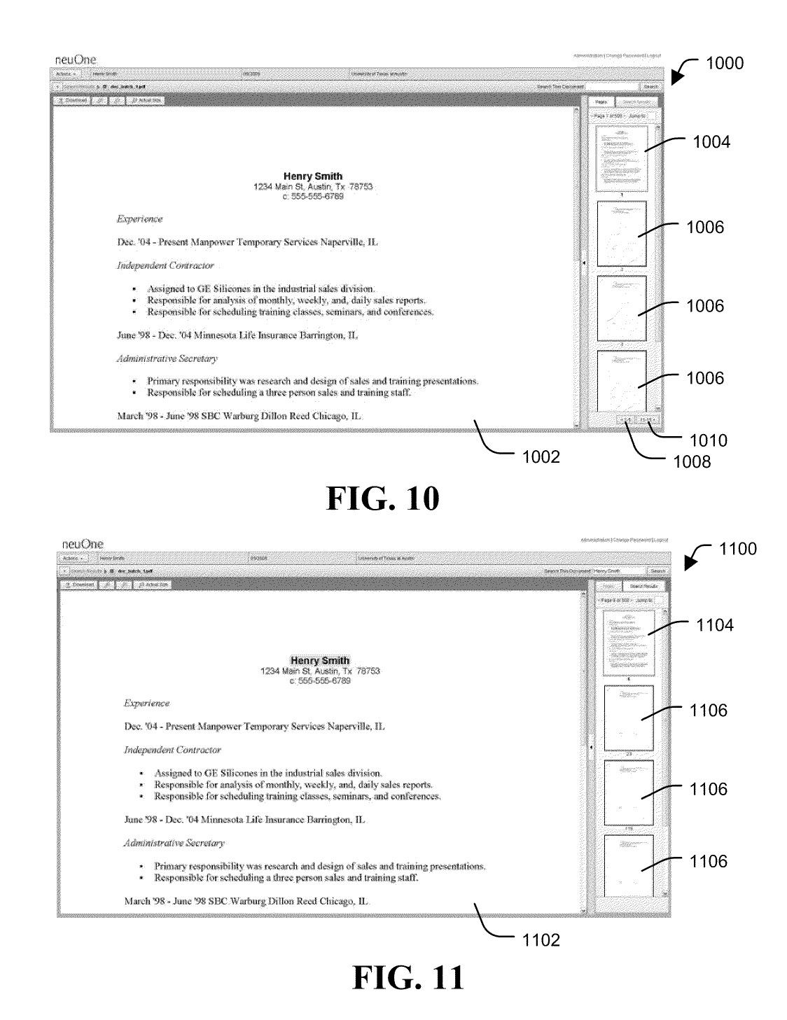

FIG. 10 depicts a document view screen 1000 of a GUI. For example, the screen shown may be displayed when a user selects the view document action 902. In one embodiment, the document view screen 1000 includes a full-size page image 1002 and multiple thumbnail images of other pages 1006. The GUI may provide a zoom-in, zoom-out, or a zoom to original size feature. The screen 1000 may also show a thumbnail image 1004 corresponding to the full-size page image 1002. Also, there may be multiple screens of thumbnail images which may be navigated to using a forward button 1010 and a backward button 1008. The multiple thumbnail images of other pages 1006 may be selected as described herein, such as consecutive pages in the same document as the full-size page, non-consecutive pages selected from the same original document as the full-size page, other pages from documents other than the original document of the full-size page.

FIG. 11 depicts a document view screen 1100 of a GUI that may be used when a user has performed a search. A full-size page image 1102 may be displayed that includes a term searched for in the search. The screen 1100 may also show a thumbnail image 1104 corresponding to the full-size page image 1102. In addition, multiple other search results may be shown as multiple thumbnail images 1106. The other search results may correspond to different pages within different documents, different pages within a same document, documents selected from a collection of documents, documents selected from a subset of the collection of documents, or any combination thereof. The search results may be shown in a search results area or tab of the GUI. The search results may show the pages with the search results, with the search term highlighted. The search results may also show a result page in relation to the rest of the pages in the document. If a user scrolls down in the search result area or in a document view area that shows multiple thumbnails, more thumbnails may be loaded either from the cache or from a server. Selecting a last thumbnail shown in a list of thumbnails may reconfigure the thumbnails shown, such as moving the last thumbnail to a top position in the list and loading other thumbnails in other positions in the list.

With respect to the methods described herein and the screen views of FIGS. 7-11, the software or applications described may be stand-alone applications or may be network-based applications that are executed via a browser or other application on a client or user device, such as a web browser. The software may include multiple views for searching and displaying documents. For example, the views can display a search capability to initiate a search to be performed within a single document or within a group of documents. Further, search results may be shown and may include thumbnail images showing relevant parts of a document, or relevant documents, in the search result. The thumbnail images may be from a single document or multiple documents.

Also, a search result may be expanded, or selected, and a specific page of a multi-page image document may be displayed full-size (i.e. at a size and quality to allow a user to view and read the image on a device screen). At the same time, the software may display one or more (e.g. five) thumbnail images. The thumbnail images may show pages that have a relationship or connection to the specific page, such as pages in the vicinity of the specific page within the multi-page image document, pages that include a search term, pages linked through a relevance indicator or by another type of connection. A relevance indicator may be a likelihood of the two pages being requested consecutively or within a same document viewing session or search result. A relevance indicator may also be user or administrative generated information that associated one or more pages. A relevance indicator may also be generated from a semantic analysis of a group of pages, or a cluster of pages, having a value a generated value that is indicative of a likelihood of relevance between documents of the group or cluster.

The software can allow a user to view, edit, or delete an entry from the search results. When a user selects view, at least one full-size image and one thumbnail image can be loaded into a viewer. When a user selects edit, a program to allow editing of the selected document can be opened along with the selected document for editing. An editing or other tool may allow a user to annotate a page or document, or redact a page or document. When the user selects delete, the software may initiate removal of the document or the single page from the search results. Removal of a document or page(s) can be accomplished by setting an ignore flag at the database to indicate a certain record is not to be included in a search result. Thus, a searching index can be built by omitting any records that have the ignore flag set.

The systems, database structures, and methods described herein can allow for the management of a document similar to that of a file system, by allowing each individual page of a multi-page document to be stored and updated individually. Thus, if a complete version of a multi-page document is (re)created from the individually stored page images, the (re)created complete version can include any pages that have been updated. Documents may be generated on-the-fly, that is, created from separately stored page images in response to a trigger. The trigger may be a command, a user input, such as a selection or input of a form, a user identification, or any other trigger that might indicate when a document may be generated.

Not all documents need to be stored as described herein; some may be stored on a page level and some may be stored on a document level. A user may elect to receive a whole document in a single transfer transaction. This can be accomplished by re-compiling the whole image document from the individually stored image pages or sending a previously stored copy of the whole image document.

Pages or documents may be associated within the relationship information of a DB to indicate a new structured file exists, such as when a user adds pages from one document to another, without the underlying page images changing. Individual pages may be edited or replaced without a need to replace the rest of the images in the same file.

In one example, in a multi-page image document, each page may become an object that is stored and managed separately. A database may keep records associated with each object, allowing changes and associations of each object to be tracked. Thus, if just one page of a document is updated, there is no need to store an entire new version of the document, instead the single page object can be updated. In some instances, only the modification or change is stored in a separate related record. Also, the modified page and the original page may both be stored, and an indicator or pointer can be set to indicate the modified page is to replace the original page when a version of the entire document is generated. This can allow for versioning. Furthermore, the same technique can apply to a compound document page where a page is composed of multiple text, graphic, or multi-media objects. Each object within a page can be managed and updated individually. Thus, multiple separate objects stored at the server can be mutually included in a first version and a second version.

Each virtual document, irrespective of a number of pages in the virtual document, may be transferred to a device via a network within a time period similar to or approximately equal to a time period to transfer a single page document.

The display order of the pages in a document can also be dynamically arranged by users of the document management system in an editing tool provided within the system. The display order of the pages within the document is saved and maintained in the database structure. Thus, allowing the order of the pages to be re-arranged and saved without a need to re-save any of the pages in the document. Further, a document can be customized for each individual user or shared among selected group of users or all system users.

The pages, images, documents, or any combination thereof may be stored on encrypted memory, such as a hard disc drive, a solid state memory, an optical memory, or any other form of data storage. The data may be encrypted either by software or hardware circuits either at an operating system or at the storage device itself. This may be useful for very sensitive data or documents, such as documents that contain personal health information, banking information, or confidential information.

In accordance with various embodiments, the methods and systems described herein may be implemented as one or more software programs running on a computer, server, or other device. In accordance with another embodiment, the methods described herein may be implemented as one or more software programs running on a client device, such as a personal computer or portable computing device. Dedicated hardware implementations including, but not limited to, application specific integrated circuits, programmable logic arrays and other hardware devices can likewise be constructed to implement the methods described herein. In accordance with other embodiments, a computer readable medium may include instructions that, when executed, cause a processor to perform one or more of the methods or systems described herein.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description. In the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a memory storing a multi-page image document and each page of the image document is stored as a separate object;
a memory storing multiple thumbnail images that each correspond to one or more pages of multiple multi-page image documents; and
a server, coupled to the memory storing the image document and the memory storing the multiple thumbnail images, configured to:
receive a page request from a device;
retrieve, from an associated memory, a full-size image of a page corresponding to the page request and at least one thumbnail image of another page; and
send the full-size image and the at least one thumbnail image to the device.

2. The system of claim 1 further comprising:
a database comprising a data structure to indicate a storage location of each separate object and a storage location of each thumbnail image;
a database server to store the database; and
a file server to store each separate object and the multiple thumbnail images.

3. The system of claim 1 further comprising an application stored on the server and provided to the device via a network, the application configured to generate the page request and display the full-sixe image and the at least one thumbnail at the device.

4. The system of claim 3 wherein the application is configured to receive the full-size image, display the full-size image, display the at least one thumbnail, receive a second full-size image from the server that was not requested by the user device, and store the second full-size image in a cache memory of the device.

5. A system comprising:
a computer including:
a page request module to receive a page request from a device over a network, the page request includes a reference to a selected page of a multi-page image document and pages of the multi-page image document are stored as separate objects;
a page relation module to select another page based on the page request, the another page not specifically identified in the page request;
a retrieval module to retrieve the selected page and at least one thumbnail image corresponding to the another page from determined storage locations; and
a distribution module to provide, from the computer to the device via the network, the selected page and the at least one thumbnail image corresponding to the another page.

6. The system of claim 5, further comprising the computer comprising:
a search request module to receive a search request from the device;
a search module to perform a search based on the search request;
a search result module to provide results based on the search request to the device, wherein the results include a listing of records from a database; and
wherein the selected page is part of the results.

7. The system of claim 6, further comprising:
a user interface application loadable by the device via the network, the user interface application including a search module to allow the search request to be generated, a search display module to display the results, a page select module to initiate the page request, a page display module to display the selected page, and a thumbnail display module to display the at least one thumbnail image of the another page.

8. The system of claim 7, further comprising:
a thumbnail selection module to determine the at least one thumbnail image corresponding to the another page; and
a locator module to access a database and determine a storage location of the selected page and the at least one thumbnail image corresponding to the another page.

9. A computer readable medium comprising instructions that, when executed, cause a processor to:
identify one or more results based on a search, the results including a selected page of a multi-page image document identified via the search;
retrieve a full-size image corresponding to the first page and a thumbnail image of a second page; and
provide the full-size image of the first page and the thumbnail image of the second page to a destination device over a network.

10. The computer readable medium of claim 9 further comprising instructions that, when executed, cause a processor to:
query a database to determine a location of the full-size image and a location of the thumbnail image;
receive a first location of the full-size image and a second location of the thumbnail image from the database; and
retrieve the full-size image from the first location and the thumbnail image from the second location.

11. The computer readable medium of claim 9 further comprising instructions that, when executed, cause a processor to:
provide a graphical user interface (GUI) application to the destination device, the GUI application loadable by the destination device over the network, the user interface application including a search module to allow a search to be generated, a search display module to display the one or more results, a page select module to select a page to view as full-size, a page display module to display a page as full-size, and a thumbnail display module to display multiple thumbnail images.

12. A method comprising:
receiving a request from a device over a network for a multi-page document;
determining a selected page to provide in response to the request;
determining at least one other page based on the request; and
providing, to the device via the network, a full-size image of the selected page and at least one thumbnail image corresponding to the at least one other page.

13. The method of claim 12 further comprising providing more than one thumbnail image to the device, each thumbnail image corresponding to pages other than the selected page based on the request.

14. The method of claim 12 further comprising:
accessing a database to determine a storage location of the selected page and a storage location of the at least one thumbnail image;
retrieving the selected page and the at least one thumbnail image from the determined storage locations;
wherein each page of multiple multi-page documents are stored as individual objects on a server comprising the storage locations; and
wherein the at least one other page is not specifically identified in the page request.

15. A method comprising:
sending a request for a specific page of a multi-page image document to a server; and
receiving, from the server, a full-size image corresponding to the specific page and at least one thumbnail image corresponding to a different page that was not identified in the request.

16. The method of claim 15 further comprising:
receiving, from the server, at least one other full-size image corresponding to a different page that was not identified in the request; and
storing the at least one other full-size image in a memory cache of a requesting device.

17. The method of claim 16 further comprising providing a user interface application to:
generate the request for the specific page;
display the full-size image corresponding to the specific page; and
display the at least one thumbnail image corresponding to the different page.

18. A method comprising providing a virtual document of unlimited size to a device over a network.

19. The method of claim 18 further comprising the virtual document having a finite number of pages comprised of one or more objects stored at a server.

20. The method of claim 19 further comprising the virtual document, irrespective of a number of pages in the virtual document, may be transferred to the device via the network in a time period similar to a time period to transfer a single page document.

21. The method of claim 19 further comprising providing multiple thumbnail images to the device, wherein each thumbnail image is representative of a page in the virtual document.

22. The method of claim 19 further comprising wherein a virtual document comprises a view provided to the device that, from a device user's perspective, includes a single document, wherein multiple parts of the single document are stored as separate objects at a server and are agglomerated and presented to the device as the single document.

23. The method of claim 22 further comprising wherein the separate files are indicated as part of the view and single document based on an indicator stored at the server.

24. The method of claim 22 further comprising deleting pages from the single document to create an edited virtual document, the edited virtual document not including pages that were deleted, wherein the pages that were deleted are stored, after deletion from the single document, as separate objects at the server and an indicator is set to indicate they are not to be included in the edited virtual document.

25. The method of claim 22 further comprising:
providing the view including a first version of the single document;
providing a second view that, from the device user's perspective, includes a second version of the single document; and
wherein the first version and the second version include different separate objects stored at the server.

26. The method of claim 25 further comprising:
determining objects to include as part of the first view and second view based on indicators associated with each page that is to be included in a particular view; and
constructing a selected view by agglomerating objects indicated to be associated with the selected view.

27. The method of claim 25 further comprising a first access control level allows a user to access the first view and a second access control level allows a user to access a second view, the first access control level allows a first number of separate objects at the server to be accessed and the second access control level allows the second number of separate objects at the server to be accessed, wherein the first number and second number are different.
